(19) United States
(12) Patent Application Publication
(10) Pub. No.: US 2005/0246728 A1
(43) Pub. Date: Nov. 3, 2005

(54) Controlling actuator movement

(75) Inventors: Raymond M. Cundiff SR., Loveland, CO (US); Darwin Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/836,727

(22) Filed: Apr. 30, 2004

(51) Int. Cl. G11B 7/00

(52) U.S. Cl. 720/660

(57) ABSTRACT

A method for interacting with a disc includes sensing movement of a disc interaction device on a data side of the disc to obtain a sensed value and controlling movement of the disc interaction device on a label side of the disc based upon the sensed value.

### BACKGROUND

In recent years, the use of optical discs, such as CDs and DVDs, for storing information has become prevalent. Due to the number of optical discs that a person may own, it is becoming increasingly important to properly label and identify such discs. In the past, this could be achieved by applying an adhesive label to the non-data side of the disc. However, the use of an adhesive label requires one to maintain an inventory of such labels and to complete the tedious process of applying the label to the disc, and the label might delaminate from the disc over time. Alternatively, a permanent marker could be used to hand-write information on the surface of the disc, but this typically provides a non-professional appearance.

One potential alternative to adhesive labels is the actual printing or otherwise forming a visual image on the non-data side of the disc. Unfortunately, existing actuators used to move the laser or other printing device cannot consistently and accurately position the printing device with respect to the non-data side of the disc. This causes visible line artifacts in the resulting printed image or label.

### BRIEF DESCRIPTION OF THE DRAWINGS

FIG. 1 is a top plan view schematically illustrating a disc interaction system with a disc interaction device in a first position along a data side of a disc according to one exemplary embodiment.

FIG. 2 is a flowchart illustrating a method for controlling movement of the disc interaction device of the disc interaction system of FIG. 1.

FIG. 3 is a flowchart illustrating another embodiment of the method for controlling movement of the disc interaction device of the disc interaction system of FIG. 1.

FIG. 4A is a top plan view schematically illustrating the disc interaction system of FIG. 1 with the disc interaction device in a second position along the data side of the disc according to one exemplary embodiment.

FIG. 4B is a top plan view schematically illustrating the disc interaction system of FIG. 1 with the disc interaction device in a third position along the data side of the disc according to one exemplary embodiment.

FIG. 4C is a top plan view schematically illustrating the disc interaction system of FIG. 1 with the disc interaction device in a fourth position along the data side of the disc.

FIG. 5 is a top plan view schematically illustrating the disc interaction system of FIG. 1 with the disc interaction device being repositioned along a label side of the disc to a first location.

FIG. 6 is a top plan view of the disc interaction system of FIG. 1 with the disc interaction device being repositioned along a label side of the disc to a second position.

### DETAILED DESCRIPTION OF THE PREFERRED EMBODIMENTS

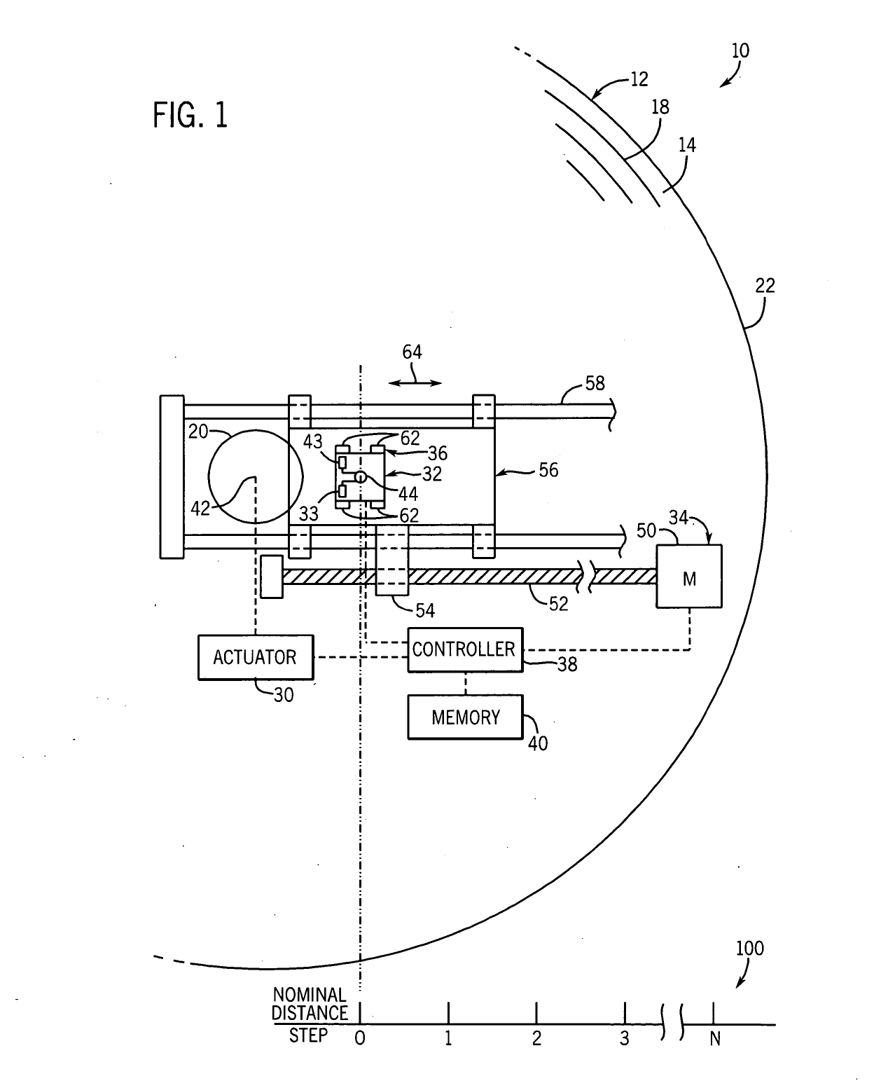

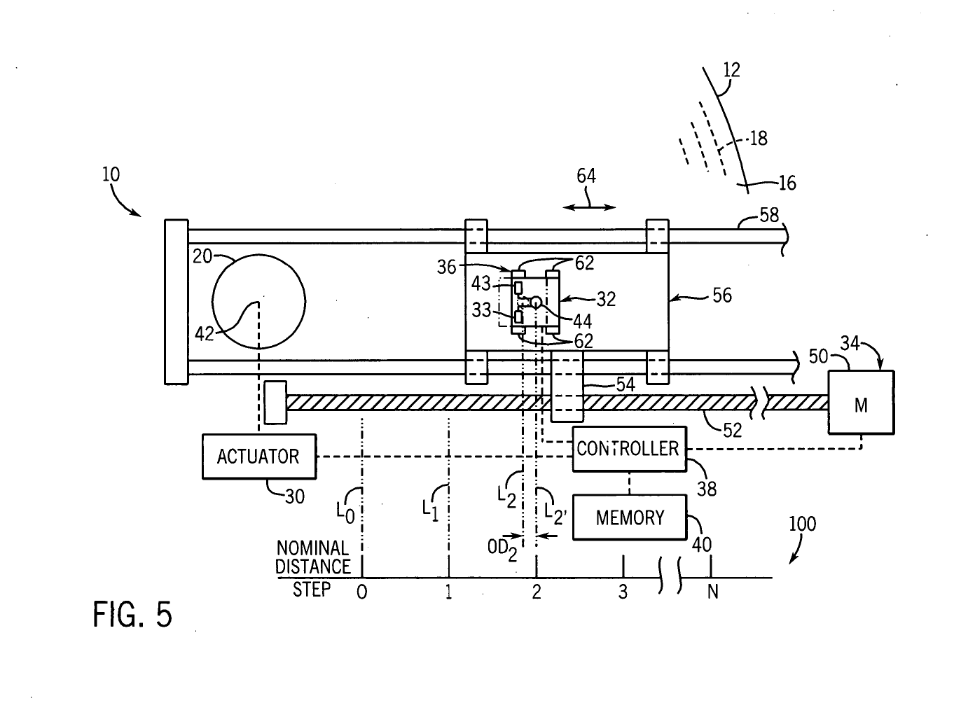

FIG. 1 is a top plan view schematically illustrating a disc interaction system 10 interacting with a disc 12 having a data face or side 14 and a label face or side 16 (shown in FIG. 5). As shown by FIG. 1, data side 14 includes a spiral track 18 along which data is recorded and stored. Track 18 spirally extends from proximate to a center most edge 20 to a circumferential edge 22 of disc 12. Spiral track 18 may be detected by system 10 during operation so as to provide real-time position information. In contrast, label side 16 of disc 12 does not include such a spiral groove, preventing disc 12 from providing system 10 with real time position feedback when system 10 is interacting with side 16.

Disc interaction system 10 is configured to interact with both side 14 and side 16 of disc 12. In one particular embodiment, disc interaction system 10 is specifically configured to form a visual image, such as a label, upon side 16. Disc interaction system 10 generally includes disc drive actuator 30, disc interaction device 32, sensor 33, coarse actuator 34, fine actuator 36, controller 38 and memory 40. Disc drive actuator 30 comprises an actuator configured to rotatably drive disc 12 about an axis 42 which extends perpendicular to side 14 of disc 12. In one particular embodiment, actuator 30 comprises a motor in communication with controller 38.

Interaction device 32 comprises a device configured to interact with sides 14 and 16 of disc 12. In one particular embodiment, disc interaction device 32 is configured to write data to side 14 and to also form visual images, such as labels, upon side 16 of disc 12. In the particular embodiment illustrated, disc interaction device 32 includes laser generating mechanism 43 and focusing device 44. Laser generating mechanism 43 comprises a device configured to generate a laser. Focusing device 44 includes one or more lenses and is configured to focus or direct the generated laser upon either side 14 or side 16 of disc 12. In one embodiment, mechanism 43 is configured to generate laser beams having at least two different energy levels to either write data to side 14 or form visual images upon side 16. In other embodiments, depending upon the configuration of disc 12, similar energy levels may be applied for writing data to side 14 or forming visual images upon side 16. Although disc interaction device 32 is illustrated and described as comprising a single laser generating mechanism 43 and focusing system 44 to perform both the writing of data to side 14 and the forming of visual images upon side 16, in other embodiments, disc interaction device 32 may alternatively utilize more than one laser generating mechanism 43 and/or more than one focusing system 44 to perform such functions. In still other embodiments, mechanism 43 and system 44 may be employed to only write data to side 14 while other non-laser visual image-forming devices, such as a printhead or image-activating heater, may be employed to form a visual image upon side 16.

Sensor 33 generally comprises a device coupled to disc interaction device 32 and configured to detect the positioning of disc interaction device 32. In particular, sensor 33 is configured to generate electrical signals which are transmitted to controller 38 and which represent the positioning of disc interaction device 32 as disc interaction device 32 is moved by actuators 34 and 36 relative to data side 14 of disc 12. In the embodiment shown, sensor 33 receives and reads laser beams reflecting from data side 14. In the particular embodiment shown, sensor 33 is specifically configured to receive or sense the laser beams generated by mechanism 43, focused by system 44 upon side 14 and reflected off of side 14. As will be described in greater detail hereafter, reflector laser beams vary as disc interaction device 32 is moved across data side 14, enabling sensor 33 to precisely determine the position of disc interaction device 32 relative to side 14 of disc 12. In other embodiments, sensor 33 may be configured to sense other characteristics of data side 14, also enabling controller 38 to determine the position of the disc interaction device 32 relative to data side 14.

Actuator 34 comprises a mechanism configured to move disc interaction device 32 across disc 12. Actuator 34 moves through distinct identifiable states. The movement of actuator 34 between each state results in disc interaction device 32 being moved across disc 12. Due to manufacturing and control variations, the actual distance moved by disc interaction device 32 as actuator 34 moves between the states varies.

In one embodiment shown in FIG. 1, actuator 34 includes stepper motor 50, worm gear 52, sleeve 54, carriage 56 and guide 58. Stepper motor 50 moves through a plurality of states in the form of steps to rotatably drive worm gear 52. The number of steps and the degree of resolution or extent of angular movement between each step depends upon a number of stator and rotor poles of motor 50. In one embodiment, stepper motor 50 moves through 18 steps during a full revolution. In other embodiments, stepper motor 50 may be configured to move through smaller increments or states known as micro steps.

Worm gear 52 is coupled to output shaft 60 of stepper motor 50 and is in engagement with sleeve 54. For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

Sleeve 54 is in meshing engagement with worm gear 52 and is coupled to carriage 56. Carriage 56 supports disc interaction device 32 and fine actuator 36. Carriage 56 is movably supported relative to disc 12 by guide 58. Guide 58 comprises one or more rails slidably supporting carriage 56. Although carriage 56 is illustrated as being movably supported by a guide 58 comprising two rails, carriage 56 may alternatively be guided across disc 12 by other support structures.

In operation, movement of stepper motor 50 through each step rotatably drives worm gear 52. Rotation of worm gear 52 drives sleeve 54 and carriage 56 along guide 58 back and forth across disc 12. In one embodiment, movement of stepper motor 50 through a single step may result in carriage 56 and disc interaction device 32 being moved across several adjacent segments of track 18. The precise positioning of device 32 relative to a particular segment of track 18 is achieved with fine actuator 36.

Fine actuator 36 comprises an actuation mechanism supported by carriage 56 and configured to further move disc interaction device 32 across disc 12 relative to carriage 56. In the particular embodiment illustrated, fine actuator 36 is configured to move disc interaction device 32 in finer increments or distances as compared to actuator 34. In the example shown, fine actuator 36 includes a voice coil 62, which upon being energized, interacts with a magnet to move disc interaction device 32 in direction indicated by arrows 64 relative to carriage 56. In other embodiments, actuator 36 may have other configurations. Actuators 34 and 36 cooperate to move disc interaction device 32 relative to disc 12 such that disc interaction device 32 is aligned with track 18.

Controller 38 generally comprises a processor configured to generate control signals for directing the operation of actuators 30, 34 and 36 as well as directing the operation of disc interaction device 32. For purposes of this disclosure, the term “processor” shall mean a conventionally known or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 38 is not limited to any specific combination of hardware circuitry and software, nor to any particular source for the instructions executed by the processing unit. As will be described in greater detail hereafter, controller 38 generates control signals which enable system 10 to detect actual distances traversed by disc interaction device 32 across side 14 which occur as actuator 34 moves between distinct states. Controller 38 further utilizes such detected actual distances to accurately and precisely control movement of disc interaction device 32 on side 16 of disc 12.

Memory 40 comprises one or more structures configured to store or contain distance data obtained during movement of device 32 across side 14 of disc 12. In one embodiment, memory stores such information in the form of one or more look-up tables. In particular embodiments, memory 40 may additionally contain instructions for use by controller 38. Memory 40 may include one or more of programmable read-only memory, non-erasable read-only memory or random access memory. Memory 40 may comprise digital memory in the form of hardwired circuitry or may comprise fixed or portable memory such as optical memory (e.g., CDs, DVDs), magnetically encodable memory (e.g., tape, floppy disk), or other forms.

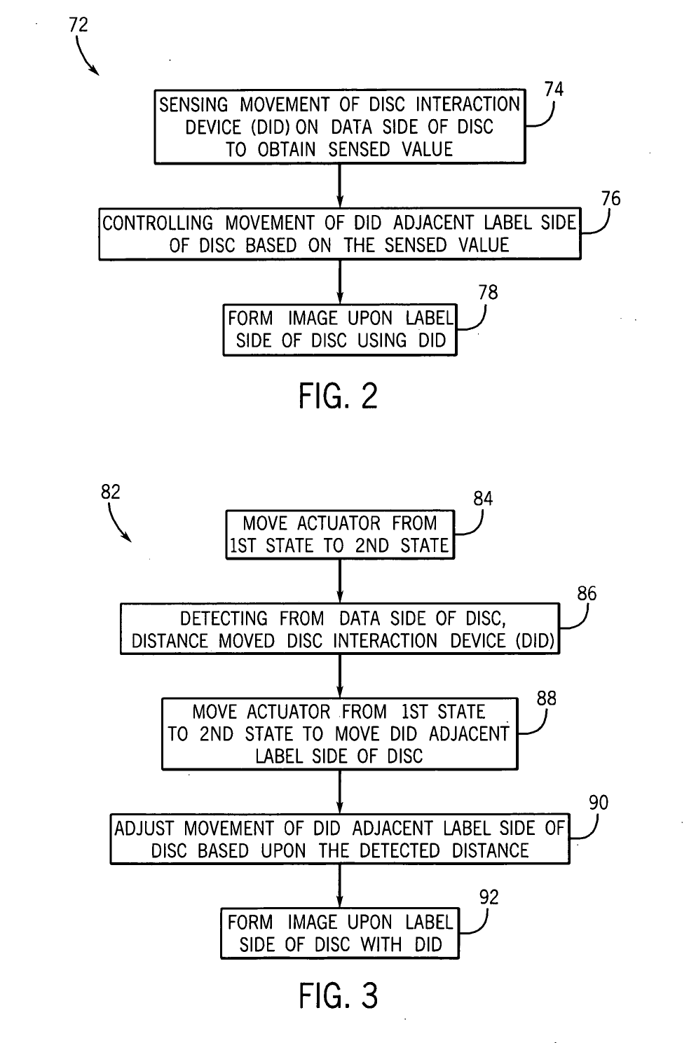

FIG. 2 is a flowchart illustrating a method 72 performed by system 10 for controlling movement of disc interaction device 32 and for interacting with disc 12. As indicated by step 74, disc interaction device (DID) 32 is moved while being positioned adjacent to data side 14 of disc 12. Sensor 33 senses the movement of disc interaction device 32.

As indicated by step 76, disc interaction device 32 is then positioned adjacent to label side 16 of disc 12. Movement of disc interaction device 32 adjacent label side 16 is controlled based upon the values sensed by sensor 33. As indicated by step 78, disc interaction device 32 is used to form one or more images upon label side 16 of disc 12.

FIG. 3 is a flowchart illustrating a particular method 82 controlling movement of disc interaction device 32. In particular, as indicated by step 84, actuator 34 is moved from a first state to a second state. In the particular embodiment illustrated in which actuator 34 includes a stepper motor, stepper motor 50 is moved through a step or a micro step. This results in disc interaction device 32 being moved.

As indicated by step 86, the distance through which disc interaction device 32 moves is detected using data side 14 of disc 12. As indicated by step 88, disc interaction device 32 is then positioned adjacent label side 16 of disc 12. Actuator 34 is once again moved from the first state to the second state to move the disc interaction device 32 adjacent the label side of the disc. As indicated by step 90, the movement of the disc interaction device adjacent the label side of the disc is adjusted based upon the detected distance from the data side of the disc. As indicated by step 92, disc interaction device 32 is utilized to form an image upon the label side 16 of disc 12.

FIGS. 1, 4A, 4B, 4C, 5 and 6 illustrate one example of a method for controlling movement of disc interaction device 32 and for interacting with disc 12. Due to, for example, manufacturing variations, the actual distance traversed by disc interaction device 32 in response to actuator 34 moving between particular states may not be consistent or uniform. For example, in those embodiments in which actuator 34 is driven by stepper motor 50, the geometry of stepper motor 50 may result in somewhat imprecise angular rotation of worm gear 52 which results in inconsistent linear movement of disc interaction device 32 along disc 12. Additional variations may be the result of, for example, manufacturing variances or tolerances associated with components such as worm gear 52, sleeve 54, carriage 56 and guide 58.

When reading data from or writing data to data side 14 of disc 12, disc interaction device 32 can be precisely positioned relative to a particular desired segment of track 18 as a result of controller 38 continuously obtaining positional feedback from data side 14 of disc 12. In one embodiment, controller 38 receives sensed additional feedback provided by track 18. For example, in one embodiment, track 18 comprises a groove with at least one sidewall having a sinusoidal radial displacement (called wobble). See, for example, U.S. Pat. No. 6,538,966 (Hanks), the full disclosure of which is hereby incorporated by reference. The wobble may be frequency modulated to encode address information. Alternatively, track 18 may comprise a groove having notches in one or more sidewalls which are used for index marks or sector addresses. See, for example, U.S. Pat. No. 5,923,401 (Inui et al.) and U.S. Pat. No. 5,852,599 (Fuji), the full disclosures of which are hereby incorporated by reference. In other embodiments, positional feedback may be obtained by controller 38 by controlling disc interaction device 32 to count track segment crossings. Positioning device 32 at a desired portion of segment of track 18 on the data side generally involves causing actuator 34 to move device 32 in larger increments a distance expected to correspond to the number of track segments to be crossed, identifying the resulting current track segments over which device 32 is located and causing fine actuator 36 to move system 44 in relatively smaller increments from the current segment of track 18 to the desired segment of track 18. Because the reflected laser beams vary depending upon whether the laser beam is reflected from track 18 or a landing between adjacent segments of track 18, disc interaction device 32 is able to count a number of track crossings made by disc interaction device 32 as disc interaction device 32 is moved across data side 14 of disc 12. Using a known distance between adjacent segments of track 18 and the number of segment crossings, controller 38 may calculate an exact position of disc interaction device 32 along data side 14 of disc 12. Because disc interaction device 32 (or another sensing device) receives position information from track 18 whether by sensing notches, whether by sensing wobble or whether by counting tracks, controller 38 is able to specifically identify the location of disc interaction device 32 and to generate control signals to correct for any inconsistent movement of disc interaction device 32 along data side 14.

However, label side 16 of disc 12 does not include tracks or track data which enable controller 38 to constantly receive real time position feedback from side 16. Therefore, controller 38 utilizes positional feedback from side 14 to generate control signals that direct the operation of actuators 34 and 36 to precisely position disc interaction device 32 adjacent side 16.

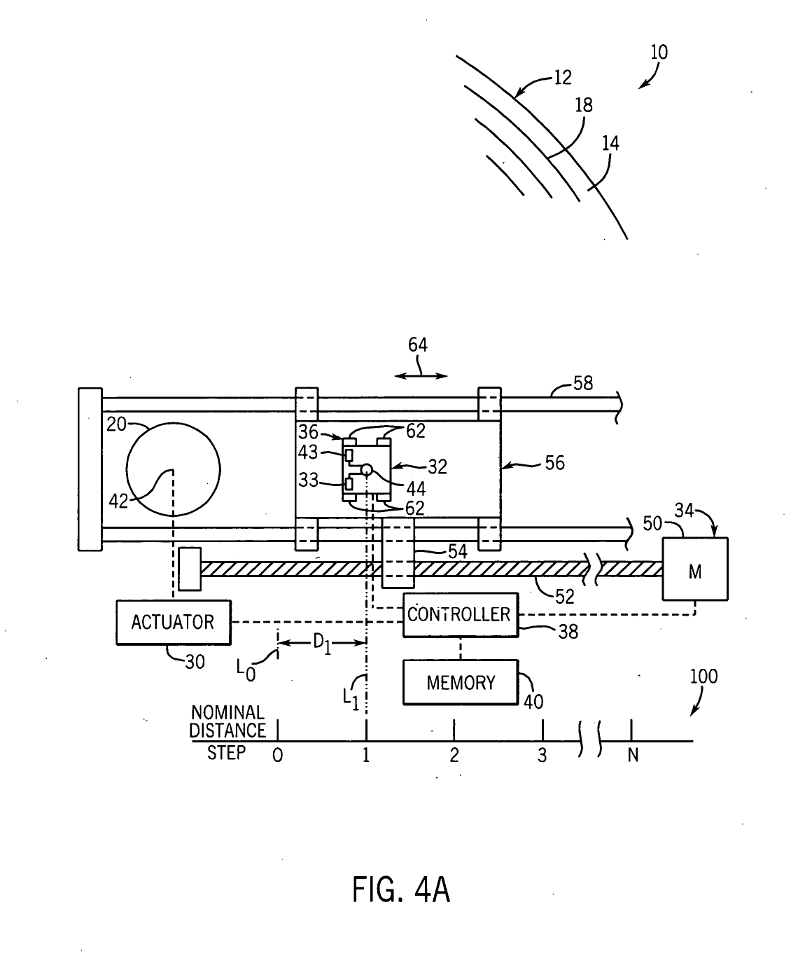

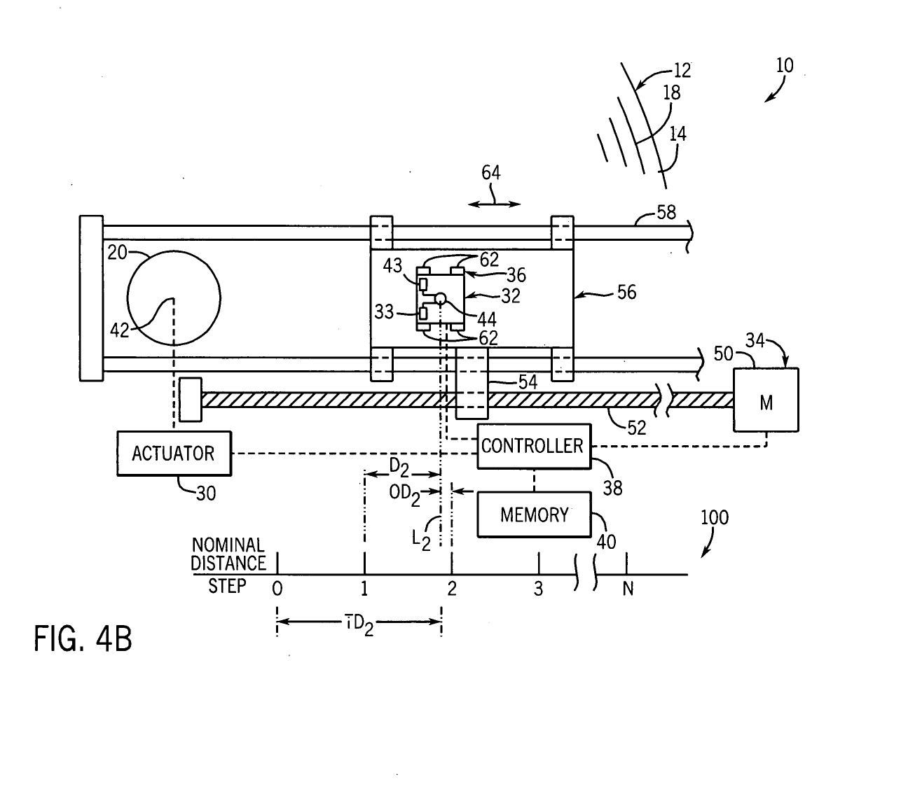

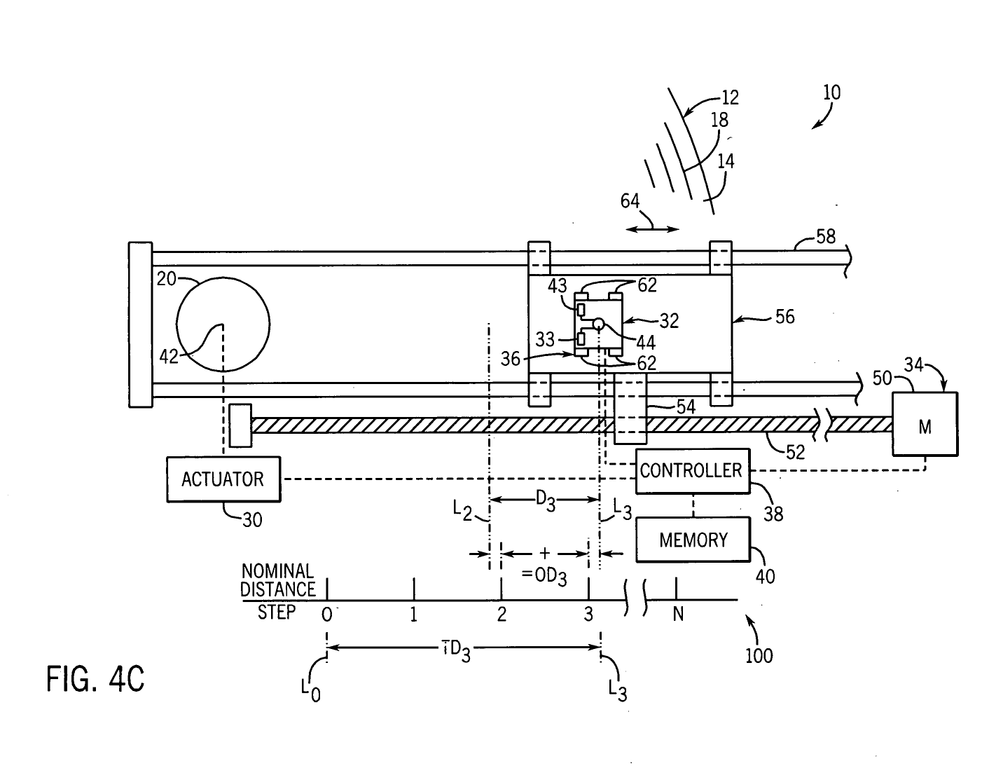

FIGS. 1, 4A-4C illustrate movement of actuator 34 through three distinct states along data side 14 of disc 12. In the particular example described, stepper motor 50 is moved through a first step, a second step and a third step in FIGS. 4A, 4B and 4C, respectively. In other embodiments, such states may alternatively comprise micro steps or may comprise other distinct states depending upon the type of actuator used.

Each of FIGS. 4A, 4B, 4C, 5 and 6 include a graduated scale 100 having graduation marks 0, 1, 2, 3. N. Each graduation mark corresponds to a linear distance from a radially inwardmost position of disc 12 (represented by graduation mark 0). The spacing between each of graduation marks 0, 1, 2, 3 . . . N is uniform and corresponds to a nominal distance which disc interaction device 32 is expected to move as a result of actuator 34 moving between consecutive steps. In one embodiment, the nominal per step distance may constitute an average or intended design distance for a series of actuators 34. In another embodiment, the nominal per step distance may be the overall average distance traversed by disc interaction device 32 during each step for a particular actuator 34. This nominal per step distance may be derived from actual distances detected by device 32 and averaged by controller 38 as actuator 34 moves through its various steps or states.

FIGS. 4A-4C illustrate potential variations with respect to the expected or the nominal distance moved by device 32 during completion of a step. FIG. 4A illustrates movement of actuator 34 from a first state to a second state (through step 1) which causes interaction device 32 to move by distance D₁ from location L₀ to location L₁. In the particular example show, distance D₁ is equal to the expected distance or average distance for movement of actuator 34 during a single step.

FIG. 4B illustrates movement of stepper motor 50 through a second step which causes disc interaction device 32 to move distance D₂ from location L₁ to location L₂ along data side 14 of disc 12. As shown by FIG. 4B, distance D₂ is less than the average or expected per step distance, resulting in location L₂ undershooting a desired location along data side 14 identified by nominal step 2. In addition, the total traveled distance TD₂ is less than the expected total distance identified by graduation mark 2.

FIG. 4C illustrates movement of stepper motor 50 through a third step which causes disc interaction device 32 to move along data side 14 by distance D₃ from location L₂ to location L₃. Distance D₃ is greater than the average or expected per step distance. In the particular example shown on FIG. 4C, distance D₃ is so large that location L₃ extends beyond or overshoots the expected total distance indicated by graduation mark 3. The total distance TD₃ exceeds the average or expected distance by which device 32 is to move during three steps.

Although not shown, controller 38 continues to generate control signals which cause stepper motor 50 to move through steps which results in disc interaction device 32 being further moved along data side 14 of disc 12. For each step that stepper motor 50 is moved through, controller 38 generates control signals which cause disc interaction device 32 to detect the actual distance traversed by device 32 across data side 14 by counting track crossings upon data side 14. The detected actual distances moved by disc interaction device 32 for each associated step of motor 50 are stored by controller 38 in memory 40.

In one particular embodiment, controller 38 stores such information in a look-up table of steps and their associated distances D₁ through D_{N}, where N represents the total number of steps required for disc interaction device 32 to be moved entirely across disc 12. An example of such a look-up table is:

STEP

| | 1 | 2 | 3 | N |
|---|---|---|---|---|
| DISTANCE | D₁ | D₂ | D₃ | D_{N} |

In another embodiment, controller 38 generates control signals which cause information to be stored in a look-up table of steps and their associated total distances TD₁, TD₂, TD₃ . . . TD_{N} from a known initial starting location such as L₀, wherein N equals the total number of steps required to move disc interaction device 32 across disc 12. An example of such a look-up table is:

STEP

| | 1 | 2 | 3 | N |
|---|---|---|---|---|
| TOTAL DISTANCE | TD₁ | TD₂ | TD₃ | TD_{N} |

In still another embodiment, controller 38 stores information in a look-up table of steps 1-N and their associated off-set distances OD₁, OD₂, OD₃ . . . OD_{N}, wherein N is the total number of steps required to move disc interaction device 32 across disc 12 and wherein each off-set distance is the distance between the expected per step distance and the actual distance D moved by interaction device 32 during a particular step. An example of such a look-up table is:

STEP

| | 1 | 2 | 3 | N |
|---|---|---|---|---|
| OFFSET DISTANCE | OD₁(=Ø) | OD₂ | OD₃ | OD_{N} |

In still another embodiment, controller 38 stores information in memory 40 in a look-up table of steps 1-N and their associated off-set total distances OTD₁ . . . OTD_{N}, wherein N equals the total number of steps required to move device 32 across disc 12 and wherein each off-set total distance is the difference between the expected total distance moved by device 32 for a particular step from an initial point along disc 12 and the actual total distance moved by device 32 along disc 14 after completion of a particular step. An example of such a look-up table is:

| | STEP | | | |
|---|---|---|---|---|
| | 1 | 2 | 3 | N |
| OFFSET TOTAL DISTANCE | OTD₁ | OTD₂ | OTD₃ | OTD_{N} |

In lieu of storing actual total distances moved by device 32 from an initial point along disc 12, controller 38 may alternatively store actual locations of device 32 after completion of an associated stop.

In particular embodiments, the actual distance D moved by device 32 during each step may repeat or exhibit a pattern. For example, stepper motor 50 may be configured to move through 18 steps to complete the full revolution of output shaft 60. The actual distances moved by device 32 for steps 19-36 may be substantially identical to the actual distances moved by device 32 during steps 1-18, respectively. In such applications, controller 38 may alternatively store information in a look-up table with values as described above, but wherein N equals the total number of steps required by motor 50 to complete one full revolution or the total number of steps through which motor 50 must move before a pattern of actual distances and their associated steps begins repeating. In such applications, controller 38 may alternatively determine and store one or more formulas for calculating one or more of actual distances D, total distances TD, locations L, offset distances OD or offset total distances OTD based upon a variable representing a completed or to be completed step. Controller 38 accesses and uses the information stored in memory 40 to control movement of device 32 on label side 16 of disc 12.

Once distance information (D, TD, L, OD, OTD) has been obtained during movement of disc interaction device 32 across data side 14 of disc 12, disc 12 is flipped or reversed such that disc interaction device 32 faces label side 16. Moving of disc 12 may occur before or after data has been written to data side 14. In one embodiment, an individual may be prompted to manually remove disc 12, to flip disc 12 and to reinsert disc 12. In still other embodiments, mechanisms may be provided for flipping disc 12 to position interaction device 32 opposite label side 16 of disc 12.

FIG. 5 illustrates one example of controller 38 controlling movement of device 32 using stored information in memory 40 which was obtained from the movement of device 32 along data side 14 of disc 12. As shown by FIG. 5, the location of device 32 is initialized at a predefined known location L₀ along side 16. L₀ on side 16 corresponds to L₀ on side 14 (shown in FIG. 1). Although the initial location L₀ is shown as being located proximate to a center of disc 12, L₀ may alternatively be at any location along disc 12 which is precisely identifiable. For example, the initial location L₀ may correspond to a maximum extent to which device 32 may be moved towards access 42 of disc 12 by actuators 34 and 36 before reaching a physical hard stop.

Once the location of device 32 has been initialized, controller 38 generates control signals which cause stepper motor 50 to be moved through its consecutive steps. Each step through which motor 50 moves causes disc interaction device 44 to radially move across more than one radial row of labellable positions on label side 16 of disc 12. Controller 38 further generates the control signals for actuating fine actuator 36 to move device 32 a fraction of the per-step distance achieved by motor 50 to precisely position disc interaction device with respect to label side 16 of disc 12. For each step through which motor 50 moves, controller 38 consults the associated stored distance information (D, TD, L, OD, OTD) and generates control signals to further control the movement of fine actuator 36 to compensate or adjust for any error caused by disc interaction device 32 moving an actual distance different than an expected nominal distance during any particular step of motor 50.

FIG. 5 illustrates an example of a scenario wherein disc interaction device 32 is to interact with label side 16 of disc 12 at location L₂′. Assuming device 32 is located at radial location L₀, controller 38 generates control signals that cause stepper motor 50 to move through a first step which causes disc interaction device 32 to move from radial location L₀ to radial location L₁. Controller 38 further generates control signals which cause stepper motor 50 to move through a second step which causes disc interaction device 32 to be moved from radial location L₁ to radial location L₂. Although radial location L₂ would ideally be equal to radial location L₂′, due to tolerances as described previously it may not be, and so controller 38 consults memory 40 for recorded distance information taken from side 14 (as shown and described with respect to FIG. 4B above). Such stored information indicates that upon completion of the second step, stepper motor 50 will have moved disc interaction device 32 to radial location L₂ which is short of the intended or expected location L₂′ by off-set distance OD₂. As a result, controller 38 generates control signals which cause fine actuator 36 to move disc interaction device 32 the additional distance OD₂ to compensate or correct for the error. The method employed by system 10 enables disc interaction device 32 to be accurately and precisely positioned at radial location L₂′ despite variations in the movement of disc interaction device 32 caused by variations of actuator 34.

In the particular example shown, disc interaction device 32 alters label side 16 of disc 12 to produce a visual image upon side 14, such as a label. In one embodiment, laser and lens assembly 44 direct a laser beam upon surface 16 which causes portions of surface 16 or underlying portions of surface 16 to have different light absorption characteristics or color thus forming the visual image. Because system 10 precisely and accurately positions interaction device 32 with respect to label side 16 of disk 12, improved higher quality images or labels are formed upon label side 16 of disc 12.

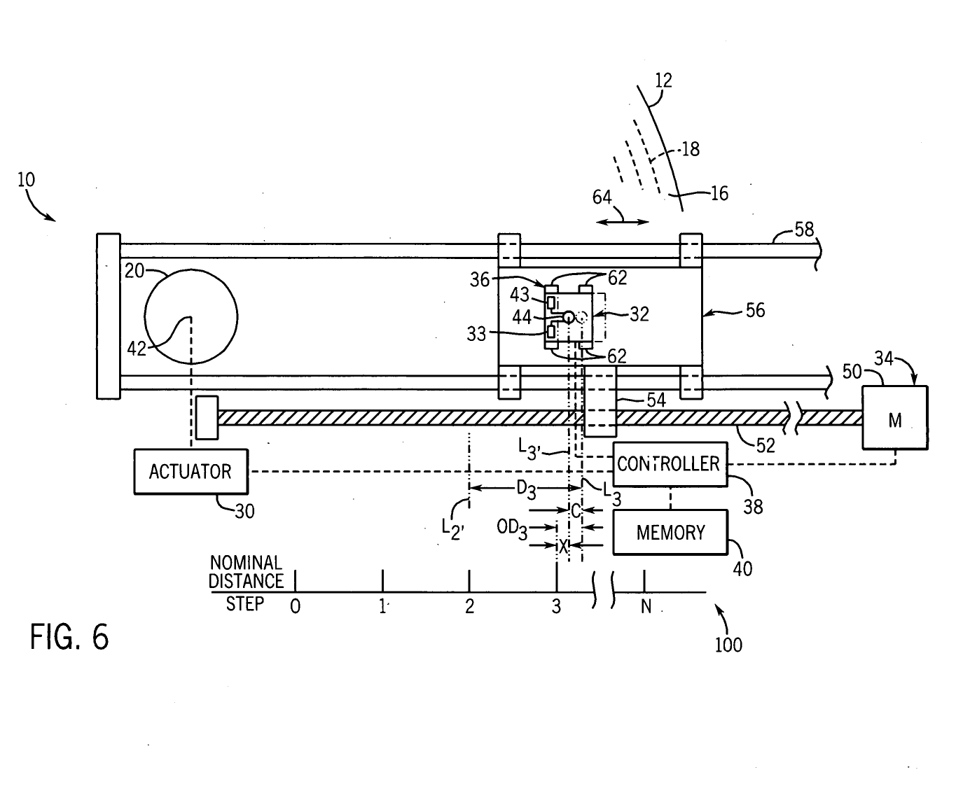

FIG. 6 illustrates the positioning of disc interaction device 32 being corrected after stepper motor 50 has moved through a third step in response to control signals from controller 38. In particular, FIG. 6 illustrates an example of a scenario wherein disc interaction device 32 is to interact with label side 16 of disc 12 at radial location L₃′. Location L₃′ is radially spaced from location L₂′, the last location of disc interaction device 32 as shown in FIG. 5, by the nominal per step distance of stepper motor 50 (the distance between graduation marks 2 and 3) and an additional intermediate distance X. To move disc interaction device 32 from the previous location of disc interaction device 32, L₂′, to the desired location of disc interaction device, L₃′, controller 38 would normally generate control signals causing stepper motor 50 to move through a step to move device 32 the nominal per step distance and would additionally generate control signals to cause fine actuator 36 to further move disc interaction device 32 the additional intermediate distance, X. However, as shown by FIG. 4C, movement of stepper motor 50 through the third step does not result in disc interaction device 32 being further moved through the nominal per step distance. In contrast, movement of stepper motor 50 through the third step results in disc interaction device 32 being moved through a distance D₃ which is greater than the nominal per step distance. To identify this discrepancy and to compensate for it, controller 38 consults memory 40 for recorded distance information taken from side 14. Such stored information indicates that upon completion of the third step, stepper motor 50 will have moved disc interaction device 32 a distance D₃ from the previous location of disc interaction device 32. In lieu of moving disc interaction device 32 to graduation mark 3 or even beyond that to location L₃′, movement of stepper motor 50 through the third step would actually cause disc interaction device 32 to move a distance D₃ to radial location L₃ beyond the desired location L₃′. Controller 38 determines radial location L₃ by adding distance D₃ to the known previous radial location L₂′ of disc interaction device 32. Controller 38 compares radial location L3 with the desired radial location L₃′ to determine a compensation or correction value C which is the difference between radial location L₃ and radial location L₃′. Controller 38 generates control signals causing fine actuator 36 to move disc interaction device 32 the compensation distance C in the appropriate direction. Generation of the control signals may occur such that actuator 36 moves disc interaction device 32 through the compensation distance C either after stepper motor 50 has completed its third step, while stepper motor 50 is moving through its third step or before stepper motor 50 is about to initiate its third step. FIG. 6 specifically shows disc interaction device 32 being moved the compensation distance C (shown in solid lines) after stepper motor 50 has completed its third step such that disc interaction device 32 is moved from location L₃ (shown in phantom) to location L₃′ (shown in solid).

The exact method by which controller 38 calculates a compensation value may vary depending upon the type of distance information obtained from movement of disc interaction device 32 along data side 14 as well as any other known differences between data side 14 and label side 16. For example, in lieu of obtaining distance D₃ from memory 40, controller 38 may alternatively obtain an offset distance OD₃ while moving stepper motor 50 through step 3. As noted above, the offset distance OD₃ is the difference between an actual distance moved by disc interaction device 32 as a result of stepper motor 50 moving through the third step and the nominal per step distance. When using the offset distance OD₃, controller 38 adjusts its control and movement of actuator 36 by subtracting offset distance OD₃ from the previously calculated incremental distance X. In particular, the offset distance OD₃ subtracted from the incremental distance (+X) results in the compensation distance (−C), wherein controller 38 generates control signals to move device 32 by the compensation distance C in the negative direction (i.e., to the left as seen in FIG. 6). In other scenarios, subtraction of the offset distance OD from the incremental distance X may result in controller 38 generating control signals to cause actuator 36 to move disc interaction device 32 in a positive direction (i.e., to the right as seen in FIG. 6) either by a compensation distance C less than or greater than the original incremental distance X. In similar fashion, other calculations may be performed by controller 38 when other distance information taken from data side 14 is used.

Overall, system 10 enables precise and accurate control of movement of disc interaction device 32 along side 16 of disc 12 by using actual distance data obtained from movement of disc interaction device 32 along side 14. In those applications in which disc interaction device 32 interacts with side 16 to form an image, such as a label, upon side 16, system 10 produces sharper images having a higher resolution. In other embodiments, disc interaction device 32 may be alternatively used to interact with side 16 of disc 12 for other purposes.

Although the present invention has been described with reference to example embodiments, workers skilled in the art will recognize that changes may be made in form and detail without departing from the spirit and scope of the invention. Those skilled in the art will appreciate that certain of these advantages can be obtained separately through reconfiguring the foregoing structure without departing from the spirit and scope of the present invention. Because the technology of the present invention is relatively complex, not all changes in the technology are foreseeable. The present invention described with reference to the example embodiments and set forth in the following claims is manifestly intended to be as broad as possible. For example, unless specifically otherwise noted, the claims reciting a single particular element also encompass a plurality of such particular elements.

1. A method for controlling movement of a disc interaction device, the method comprising:
moving an actuator from a first state to a second state to move a disc interaction device positioned adjacent a data side of the disc;
detecting from the data side of the disc a distance moved by the disc interaction device;
moving the actuator from the first state to the second state to move the disc interaction device positioned adjacent a label side of the disc; and
adjusting movement of the disc interaction device adjacent the label side of the disc based upon the detected distance.

2. The method of claim 1 comprising:
repositioning the disc so as to move the disc interaction device from adjacent the data side to adjacent the label side.

3. The method of claim 1, wherein the actuator comprises a stepper motor and wherein moving the actuator from the first state to the second state includes moving the stepper motor through at least a microstep.

4. The method of claim 1, wherein detecting the first distance includes detecting data track crossings on the data side of the disc.

5. The method of claim 1, wherein adjusting movement of the disc interaction device includes moving the disc interaction device.

6. The method of claim 1 including comparing the first detector distance to an expected distance to determine a compensation value.

7. The method of claim 5 including storing the compensation value.

8. The method of claim 1 including:
comparing the detected distance to an expected distance to determine a compensation value corresponding to movement of the actuator between the first state and the second state; and
storing the compensation value.

9. The method of claim 8, wherein the first compensation value is different than the second compensation value.

10. The method of claim 8 including storing the compensation value in a look up table corresponding to movement of the first actuator from the first state to the second state.

11. The method of claim 1 including:
moving the first actuator from the first state to the second state a plurality of times;
detecting the first distance moved by the disc interaction device on the data side of the disc a plurality of times;
determining an average of the detected first distances, wherein adjusting movement of the disc interaction device on the label side of the disc is based upon the determined average.

12. The method of claim 11 including:
comparing the average of each detected distance for each move of the first actuator from the first state to the second state to determine the compensation value for each move from the first state to the second state.

13. The method of claim 10 including storing the compensation value for a move from the first state to the second state.

14. The method of claim 1 including altering the label side of the disc.

15. The method of claim 14 including forming a visual image upon the label side of the disc.

16. The method of claim 1, wherein movement of the disc interaction device is adjusted by determining a compensation value from a formula.

17. The method of claim 1, wherein the first distance is a distance moved by the disc interaction device during movement of the first actuator from the first state to the second state.

18. The method of claim 1, wherein the first distance is a total distance moved by the disc interaction device from a starting location on the data side of the disc.

19. A method for interacting with a disc, the method comprising:
moving a first actuator from a first state to a second state to move a disc interaction device a first distance on a label side of a disc; and
moving the disc interaction device a second distance on the label side of the disc based upon a first stored compensation value.

20. The method of claim 19, wherein the disc interaction device is moved the second distance by a second actuator.

21. The method of claim 19 including:
moving the first actuator from a second state to a third state to move the disc interaction device a third distance on the label side of the disc; and
moving the disc interaction device a fourth distance on the label side of the disc based upon a second stored compensation value.

22. The method of claim 21, wherein the first compensation value is different than the second compensation value.

23. The method of claim 21, wherein the first compensation value and the second compensation value are stored in a look up table corresponding to movement of the first actuator from the first state to the second state and from the second state to the third state, respectively.

24. The method of claim 19 including altering the label side of the disc.

25. The method of claim 24 including forming a visual image upon the label side of the disc.

26. The method of claim 19 wherein the first actuator includes a stepper motor and wherein moving the first actuator from the first state to the second state includes moving the stepper motor through at least a microstep.

27. The method of claim 19 including determining the first store compensation value from a formula.

28. The method of claim 19 including repeatedly moving the disc interaction device a second distance on the label side of the disc based upon the first compensation value as the disc interaction device moves between different positions on the label side of the disc.

29. The method of claim 19, wherein the disc interaction device includes a laser.

30. A processor readable medium comprising:
a set of instructions configured to direct a processor to generate control signals to:
move an actuator from a first state to a second state to move a disc interaction device on the data side of a disc;
detect a distance moved by the disc interaction device on the data side of the disc;
move the actuator from the first state to the second state to move the data interaction device on the label side of the disc; and
adjust movement of the disc interaction device on the label side of the disc based upon the detected distance.

31. A processor readable medium comprising:
a set of instructions configured to direct a processor to generate control signals to:
move an actuator from a first state to a second state to move a disc interaction device a first distance adjacent a label side of the disc; and
moving the disc interaction device a second distance adjacent the label side of the disc based upon a stored compensation value.

32. A processor readable medium comprising:
a set of data configured to provide a processor with a compensation value corresponding to movement of an actuator from a first state to a second state, whereby the processor generates control signals to move a disc interaction device on a label side of the disc based upon the compensation value.

33. A disc labeling system for forming a visual image upon a label side of a disc, the system comprising:
a disc interaction device configured to form a visual image upon the label side of the disc;
a first actuator coupled to the disc interaction device and configured to move from a first state to a second state to move the disc interaction device relative to a disc;
a sensor configured to detect a first distance moved by the disc interaction device when positioned adjacent a data side of the disc;
a second actuator coupled to the disc interaction device; and
a controller configured to generate control signals based at least in part upon the sensed first distance, wherein the second actuator moves the disc interaction device in response to the control signals when the device is positioned adjacent the label side of the disc.

34. The system of claim 33, wherein the disc interaction device includes a laser.

35. The system of claim 33, wherein the first actuator includes a stepper motor.

36. The system of claim 33, wherein the sensor is configured to count track crossings on the second side of the disc.

37. The system of claim 33 including a memory configured to store values based upon the sensed first distance.

38. The system of claim 33, wherein the first distance is a distance moved by the disc interaction device during movement of the first actuator from the first state to the second state.

39. The system of claim 33, wherein the first distance is a total distance moved by the disc interaction device from an initial location on the second side of the disc.

40. A disc labeling system comprising:
a disc interaction device;
an actuator configured to move the disc interaction device relative to a disc;
means for detecting actual distances traversed by the disc interaction device on a first side of a disc in response to the actuator moving between a first state and a second state; and
means for moving the disc interaction device on a second side of a disc based at least in part upon the detected actual distances.

41. A method for interacting with a disc, the method comprising:
sensing movement of a disc interaction device on a data side of the disc to obtain a sensed value; and
controlling movement of the disc interaction device on a label side of the disc based upon the sensed value.

42. A disc labeling system, comprising:
a disc interaction device;
a first actuator operable to move the disk interaction device to a set of radial locations, each location having an offset distance between an expected position and an actual position;
a sensor configured to detect a tracking feature on the disc when the disc interaction device is positioned adjacent a data side of the disc, the offset distance determinable from the detected tracking feature; and
a second actuator operable to move the disc interaction device the offset distance so as to locate the disc interaction device at the expected position when the disc interaction device is positioned adjacent a label side of the disc, the tracking feature undetectable from the label side.

43. The system of claim 42, comprising:
a controller configured to operate the first actuator, determine the offset distance from the detected tracking feature, and operate the second actuator.

44. The system of claim 43, wherein the disc interaction device is operable by the controller to form a visual image upon the label side of the disc.

45. The system of claim 42, wherein the sensor is mounted to the disc interaction device.

46. The system of claim 42, wherein the tracking feature includes a spiral track, and wherein the sensor is configured to count track crossings.

47. The system of claim 43, comprising:
a memory coupled to the controller and configured to store the determined offset distance for each radial location.
